(19) United States
(12) Patent Application Publication
(10) Pub. No.: US 2015/0008994 A1
(43) Pub. Date: Jan. 8, 2015

(54) INTERFACE APPARATUS

(71) Applicant: NEC Corporation, Minato-ku, Tokyo (JP)

(72) Inventors: Naoki Kobayashi, Tokyo (JP); Tsuneo Tsukagoshi, Tokyo (JP); Koichiro Nakase, Tokyo (JP); Hiroshi Fukuda, Tokyo (JP)

(73) Assignee: NEC CORPORATION, Minato-ku, Tokyo (JP)

(21) Appl. No.: 14/371,519

(22) PCT Filed: Nov. 26, 2012
(86) PCT No.: PCT/JP2012/007564

§ 371 Date: Jul. 10, 2014

(30) Foreign Application Priority Data
Jan. 12, 2012 (JP) 2012-004001

(51) Int. Cl. H01P 5/00

(52) U.S. Cl. CPC H01P 5/00
USPC 333/24 R; 333/248

(57) ABSTRACT

An object of the present invention is to provide an interface apparatus which can suppress leakage of electromagnetic waves and supply electromagnetic waves efficiently without limiting applications or mounting positions. An interface apparatus (200) is provided that supplies electromagnetic waves to a sheet-shaped electromagnetic wave transmission medium for propagating electromagnetic waves and includes a first conductor surface, a second conductor surface disposed in an opposed state to and substantially parallel with the first conductor surface, electromagnetic wave supplying means (230) configured to supply electromagnetic waves to a gap between the first and second conductor surfaces, a first structure (240), and a second structure (250). The first and second structure (240 and 250) are respectively disposed on the first and second conductor surface and configured to reflect electromagnetic waves supplied by the electromagnetic wave supplying means with an end of the electromagnetic wave transmission medium inserted in the gap.

### TECHNICAL FIELD

The present invention relates to an interface apparatus and in particular to an interface apparatus which supplies electromagnetic waves to a communication sheet which allows electromagnetic waves to propagate through the region between a mesh sheet-shaped conductor layer and sheet-shaped conductor layer of the communication sheet so that communication is conducted.

### BACKGROUND ART

In recent years, electromagnetic wave transmission media have been developed which allow electromagnetic waves to propagate through the region between a mesh sheet-shaped conductor layer (mesh conductor layer) and a sheet-shaped conductor layer (sheet conductor layer) serving as a transmission path and to couple with electromagnetic waves in the leakage region leaking from the mesh conductor layer so that communication can be conducted (e.g., Patent Literature 1). The communication system where communication is conducted by coupling electromagnetic waves propagating through the transmission path with evanescent waves, which are electromagnetic waves leaking from the mesh conductor layer of the electromagnetic wave transmission medium (hereafter referred to as the “communication sheet”), is called “surface communication.”

Various types of interface apparatuses which supply electromagnetic waves to the communication sheet have also been developed. For example, Patent Literature 2 discloses an interface apparatus which supplies electromagnetic waves to the communication through the mesh conductor layer from over the communication sheet. Since this interface apparatus is a mounting type one, it is advantageous in that it can transmit power from any position regardless of the location of the communication sheet. Patent Literature 3 discloses an interface apparatus which is such a mounting type one and transmits power with increased efficiency by reducing leakage of electromagnetic waves.

While the interface apparatus disclosed in Patent Literature 3 transmits power with increased efficiency by reducing leakage of electromagnetic waves, in order to supply sufficient electromagnetic waves to the entire communication sheet using this power transmission system, upsizing of the interface apparatus is required. However, up sizing of the mounting-type interface apparatus would have the unfavorable effect of reducing the area of the communication sheet available for receiving apparatus.

For this reason, interface apparatuses which supply electromagnetic waves from the side surfaces of the communication sheet have been developed. Patent Literature 4 discloses a clip-type interface apparatus configured to vertically sandwich an end of a communication sheet between two electrodes thereof opposed to a mesh conductor layer and a sheet conductor layer included in the communication sheet and to supply electromagnetic waves from the side surfaces of the communication sheet. This interface apparatus can transmit power more efficiently than the interface apparatus of Patent Literature 2 does.

Patent Literature 5 discloses an interface apparatus which is a clip-type interface apparatus similar to Patent Literature 4 and which can transmit power much more efficiently owing to its configuration which is capable of reducing leakage of electromagnetic waves.

### CITATION LIST

### Patent Literature

[Patent Literature 1] International Patent Publication No. WO2007/032049

[Patent Literature 2] Japanese Unexamined Patent Application Publication No. 2007-82178

[Patent Literature 3] International Patent Publication No. WO2011/052361

[Patent Literature 4] Japanese Unexamined Patent Application Publication No. 2010-16592

[Patent Literature 5] Japanese Unexamined Patent Application Publication No. 2011-9801

### SUMMARY OF INVENTION

### Technical Problem

In an actual communication sheet, a mesh conductor layer and a sheet conductor layer are each covered by a protective layer having a predetermined thickness to electrically isolate from outside. A problem with the clip-type interface apparatus of Patent Literature 4 is that when power is transmitted from the side surfaces of the communication sheet using the interface apparatus, electromagnetic waves propagate through the protective layer and emanate therefrom as leaking electromagnetic waves.

Similarly, a problem with the clip-type interface apparatus of Patent Literature 5 is that when the communication sheet and the interface apparatus are displaced from each other, electromagnetic waves propagates through the protective layer as a path and leak therefrom. Prevention of such leaking electromagnetic waves requires exactly fixing the communication sheet and the interface apparatus. This is problematic not only in that applications of the interface apparatus are limited but also in that the connection position of the interface to the communication sheet is inevitably limited.

The present invention has been made in view of the foregoing, and an object thereof is to provide an interface apparatus which can suppress leakage of electromagnetic waves and supply electromagnetic waves efficiently without limiting applications or mounting positions of the apparatus.

### Solution to Problem

An interface apparatus according to an aspect of the present invention is an interface apparatus for supplying electromagnetic waves to a sheet-shaped electromagnetic wave transmission medium for propagating electromagnetic waves, the interface apparatus including: a first conductor surface; a second conductor surface disposed in an opposed state to and substantially parallel with the first conductor surface; electromagnetic wave supplying means configured to supply electromagnetic waves to a gap between the first and second conductor surfaces; a first structure disposed on the first conductor surface and configured to reflect electromagnetic waves supplied by the electromagnetic wave supplying means with an end of the electromagnetic wave transmission medium inserted in the gap; and a second structure disposed on the second conductor surface and configured to reflect electromagnetic waves supplied by the electromagnetic wave supplying means with the end of the electromagnetic wave transmission medium inserted in the gap.

### Advantageous Effects of Invention

According to the present invention, it is possible to provide an interface apparatus which can suppress leakage of electromagnetic waves and supply electromagnetic waves efficiently without limiting applications or mounting positions of the apparatus.

### BRIEF DESCRIPTION OF DRAWINGS

FIG. 1 shows the configuration of a surface communication system according to a first embodiment.

FIG. 2 is a sectional view of an electromagnetic wave transmission medium (communication sheet) according to the first embodiment.

FIG. 3 is a side view of an interface apparatus according to the first embodiment in which the electromagnetic wave transmission medium is inserted.

FIG. 4A is a side view of an interface apparatus according to a second embodiment.

FIG. 4B is a plan view of the interface apparatus according to the second embodiment.

FIG. 5A is a side view of a modification of the interface apparatus according to the second embodiment.

FIG. 5B is a plan view of the modification of the interface apparatus according to the second embodiment.

FIG. 6A is a side view of a modification of the interface apparatus according to the second embodiment.

FIG. 6B is a plan view of the modification of the interface apparatus according to the second embodiment.

FIG. 7A is a side view of an interface apparatus according to a third embodiment in which the electromagnetic wave transmission medium is inserted.

FIG. 7B is a plan view of the interface apparatus according to the third embodiment in which the electromagnetic wave transmission medium is inserted.

FIG. 8A is a side view of a modification of the interface apparatus according to the third embodiment in which the electromagnetic wave transmission medium is inserted.

FIG. 8B is a plan view of the modification of the interface apparatus according to the third embodiment in which the electromagnetic wave transmission medium is inserted.

FIG. 9A is a side view of a modification of the interface apparatus according to the third embodiment in which the electromagnetic wave transmission medium is inserted.

FIG. 9B is a plan view of the modification of the interface apparatus according to the third embodiment in which the electromagnetic wave transmission medium is inserted.

FIG. 10A is a side view of an interface apparatus according to a fourth embodiment in which the electromagnetic wave transmission medium is inserted.

FIG. 10B is a plan view of an interface apparatus according to the fourth embodiment in which the electromagnetic wave transmission medium is inserted.

FIG. 11A is a side view of a modification of the interface apparatus according to the fourth embodiment in which the electromagnetic wave transmission medium is inserted.

FIG. 11B is a plan view of the modification of the interface apparatus according to the fourth embodiment in which the electromagnetic wave transmission medium is inserted.

FIG. 12A is a sectional view of a second conductor surface of an interface apparatus according to a fifth embodiment.

FIG. 12B is a bottom view of the second conductor surface of the interface apparatus according to the fifth embodiment.

FIG. 13A is a sectional view of a first conductor surface of an interface apparatus of the present invention.

FIG. 13B is a plan view of the first conductor surface of an interface apparatus of the present invention.

### DESCRIPTION OF EMBODIMENTS

Now, preferred embodiments of the present invention will be described with reference to the drawings. However, the embodiments do not limit the scope of the invention. In the following description, the same reference signs represent substantially similar components.

### First Embodiment

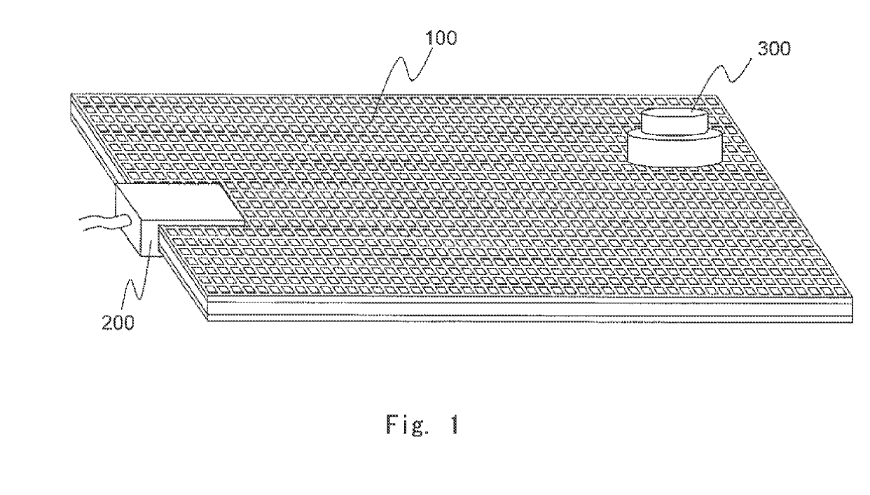

A first embodiment of the present invention will be described with reference to the drawings. FIG. 1 shows the configuration of a surface communication system 1000 according to the first embodiment. The surface communication system 1000 includes a sheet-shaped electromagnetic wave transmission medium 100 configured to propagate electromagnetic waves, an interface apparatus 200 configured to supply electromagnetic waves to the electromagnetic wave transmission medium 100, and a receiving apparatus 300 configured to receive signals by coupling with electromagnetic waves leaking from a surface of the electromagnetic wave transmission medium 100. In the present embodiment, the electromagnetic wave transmission medium 100 is a communication sheet configured to propagate electromagnetic waves supplied by the interface apparatus 200 in a direction along a sheet surface thereof. Such a communication sheet may be called an electromagnetic wave propagation sheet, electromagnetic wave transmission sheet, or the like.

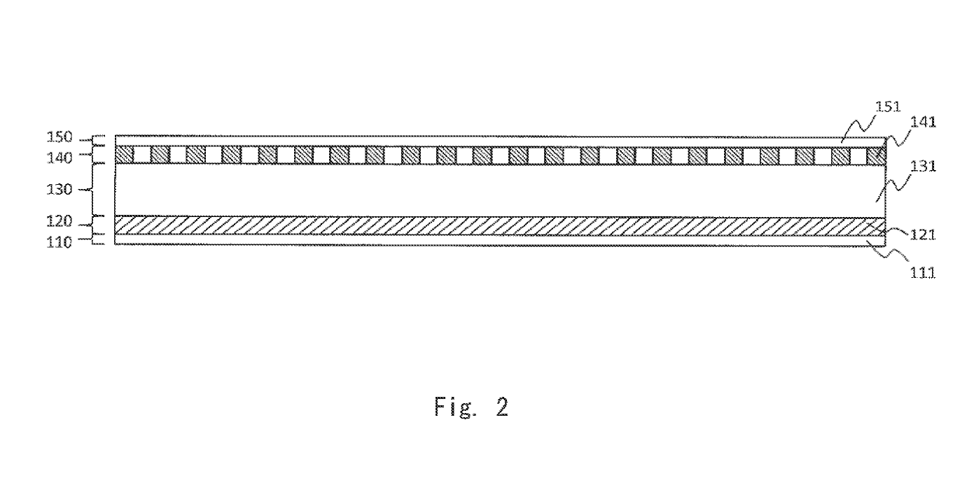

FIG. 2 shows a sectional view of the electromagnetic wave transmission medium 100. In the electromagnetic wave transmission medium 100, a first protective layer 110, a plane conductor layer 120, an electromagnetic wave propagation layer 130, a mesh layer 140, and a second protective layer 150 are stacked.

The electromagnetic wave propagation layer 130 is a layer through which electromagnetic waves supplied by the interface apparatus 200 propagate.

Specifically, this layer is formed of a sheet-shaped dielectric substrate 131. As used herein, “sheet-shaped” means having a wide surface and being thin; for example, having a shape like a cloth, paper, foil, plate, membrane, film, or mesh.

The plane conductor layer 120 is a sheet-shaped sheet conductor 121 and is formed on one of the surfaces of the dielectric substrate 131.

The mesh layer 140 consists of a mesh-shaped mesh conductor 141 and is formed on one of the surfaces of the dielectric substrate 131 opposite to the surface facing the sheet conductor 121; that is, the surface thereof remote from the sheet conductor 121. As used herein, “mesh-shaped” means that apertures having a size smaller than the wavelength of electromagnetic waves propagating through the electromagnetic wave propagation layer 130 are periodically formed.

The first protective layer 110 is a sheet-shaped sheet insulator 111 and formed in order to keep the sheet conductor 121 serving as the plane conductor layer 120 electrically insulated from outside.

The second protective layer 150 is a sheet-shaped sheet insulator 151 and formed in order to keep the mesh conductor 141 serving as the mesh layer 140 electrically insulated from outside. The medium of the sheet insulators 111 and 151 is a medium which has a particular dielectric constant and magnetic susceptibility and which does not transmit a direct current.

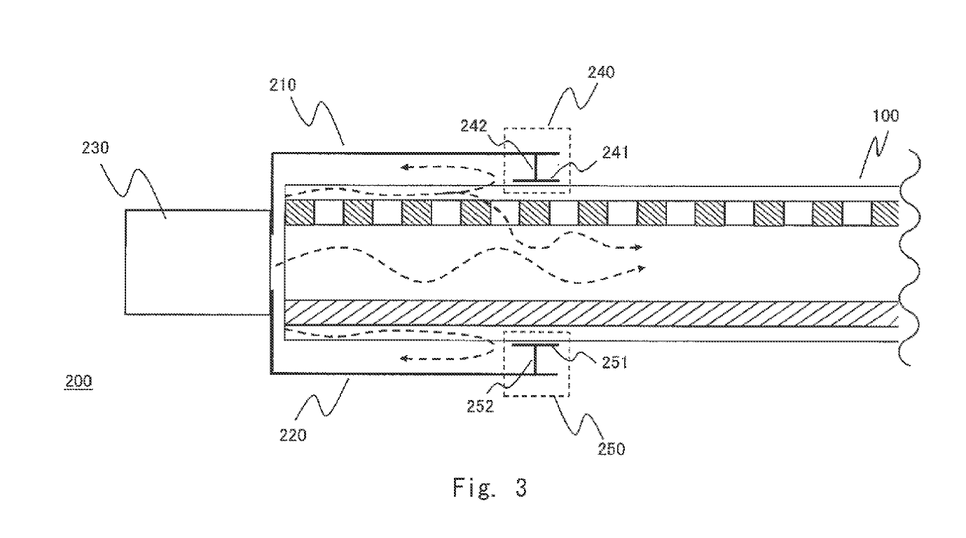

Next, the configuration of the interface apparatus 200 will be described in detail. FIG. 3 is a side view showing a state in which an end of the electromagnetic wave transmission medium 100 is inserted in the interface apparatus 200 and held thereby. The interface apparatus 200 includes a first electrode 210, a second electrode 220, an electromagnetic wave supplying portion 230, a first electromagnetic wave suppressing structure 240, and a second electromagnetic wave suppressing structure 250. As seen also from FIG. 3, the interface apparatus 200 has a clip-like shape, so that it holds the electromagnetic wave transmission medium 100 inserted therein in such a manner as to sandwich the medium vertically.

The first electrode 210 is a conductor and is connected to the electromagnetic wave supplying portion 230. The first electrode 210 has a flat conductor surface covering part of the front surface of the electromagnetic wave transmission medium 100, which is inserted in the interface apparatus 200. In the following description, this conductor surface of the first electrode 210 will be referred to as the first conductor surface.

The second electrode 220 is a conductor and is connected to the electromagnetic wave supplying portion 230. The second electrode 220 has a flat conductor surface covering part of the bottom surface of the electromagnetic wave transmission medium 100, which is inserted in the interface apparatus 200. In the following description, this conductor surface of the second electrode 220 will be referred to as the second conductor surface. The first conductor surface of the first electrode 210 and the second conductor surface of the second electrode 220 are formed in an opposed state to and substantially parallel with each other.

The electromagnetic wave supplying portion 230 supplies electromagnetic waves to a gap between the first and second conductor surfaces. Specifically, a first voltage terminal of the electromagnetic wave supplying portion 230 is connected to one of the first electrode 210 and the second electrode 220, so that a first voltage is applied to the one electrode. On the other hand, a ground terminal of the electromagnetic wave supplying portion 230 is connected to the other electrode, so that the other electrode is connected to a ground potential. Alternatively, both the first electrode 210 and the second electrode 220 may be connected to the ground terminal.

For example, the electromagnetic wave supplying portion 230 is a power supply cable. The first voltage terminal of the electromagnetic wave supplying portion 230 serving as a core wire is connected to the first electrode 210, so that the first voltage is applied to the first electrode 210, whereas a braided wire of the electromagnetic wave supplying portion 230 serving as a ground terminal is connected to the second electrode 220, so that the second electrode 220 is connected to a ground potential. The electromagnetic wave supplying portion 230 supplies electromagnetic waves to the electromagnetic wave propagation layer 130 through the side surfaces of the electromagnetic wave transmission medium 100, which is inserted in the interface apparatus 200. Then the electromagnetic waves propagate through this layer. In this way, the electromagnetic waves are used in the communication with the receiving apparatus 300. The frequency band of such electromagnetic waves for communication may be, for example, a 900 MHz band.

The first electromagnetic wave suppressing structure 240 is disposed on the first conductor surface of the first electrode 210. It reflects electromagnetic waves supplied by the electromagnetic wave supplying portion 230 in a state in which the end of the electromagnetic wave transmission medium 100 is inserted in the gap between the first and second conductor surfaces.

Specifically, the first electromagnetic wave suppressing structure 240 is an electromagnetic band-gap (EBG) structure including a rectangular plate-shaped patch conductor 241 disposed in an opposed state to and substantially parallel with the first conductor surface of the first electrode 210 and a first conductor post 242 connecting the patch conductor 241 to the first conductor surface. As used herein, a “patch” refers to a chip or piece. As a plate-shaped micro-strip antenna is called a “patch antenna,” a “patch” is commonly used in the above meaning in the field of electromagnetic wave engineering.

As shown by a broken-line arrow of FIG. 3, of the electromagnetic waves supplied by the electromagnetic wave supplying portion 230, those which are propagating along the second protective layer 150 of the electromagnetic wave transmission medium 100 and will leak out from the interface apparatus 200 are suppressed by the first electromagnetic wave suppressing structure 240. More specifically, the first electromagnetic wave suppressing structure 240 reflects electromagnetic waves propagating outward along the second protective layer 150, which is located between the first conductor surface of the first electrode 210 and the mesh conductor 141 of the electromagnetic wave transmission medium 100, toward the electromagnetic wave supplying portion 230, or reflects such electromagnetic waves so that the electromagnetic waves are sent into the electromagnetic wave propagation layer 130 through the mesh layer 140.

To allow the first electromagnetic wave suppressing structure 240 to suppress leakage of electromagnetic waves in this way, it is preferable to design the first electromagnetic wave suppressing structure 240 so that the region between the patch conductor 241 and the mesh conductor 141 has an extremely high or extremely low characteristic impedance as a transmission path. Specifically, this is accomplished by configuring the first electromagnetic wave suppressing structure 240 so that it resonates around the frequency band of electromagnetic waves supplied by the electromagnetic wave supplying portion 230.

The second electromagnetic wave suppressing structure 250 is disposed on the second conductor surface of the second electrode 220. The second electromagnetic wave suppressing structure 250 reflects electromagnetic waves supplied by the electromagnetic wave supplying portion 230 in a state in which the end of the electromagnetic wave transmission medium 100 is inserted in the gap between the first and second conductor surfaces.

Specifically, the second electromagnetic wave suppressing structure 250 is an EBG structure including a plate-shaped patch conductor 251 disposed in an opposed state to and substantially parallel with the second conductor surface of the second electrode 220 and a second conductor post 252 connecting the patch conductor 251 to the second conductor surface.

As shown by a broken-line arrow of FIG. 3, of electromagnetic waves supplied by the electromagnetic wave supplying portion 230, those which are propagated along the first protective layer 110 of the electromagnetic wave transmission medium 100 and will leak out from the interface apparatus 200 are suppressed by the second electromagnetic wave suppressing structure 250. More specifically, the second electromagnetic wave suppressing structure 250 reflects electromagnetic waves propagating outward along the first protective layer 110, which is located between the second conductor surface of the second electrode 220 and the sheet conductor 121 of the electromagnetic wave transmission medium 100, toward the electromagnetic wave supplying portion 230.

As with the first electromagnetic wave suppressing structure 240, it is preferable to design the second electromagnetic wave suppressing structure 250 so that the region between the patch conductor 251 and the sheet conductor 121 has an extremely high or extremely low characteristic impedance as a transmission path.

As described above, the electromagnetic wave interface apparatus of the first embodiment includes the first conductor surface and the second conductor surface disposed in an opposed state to and substantially parallel with the first conductor surface. The sheet-shaped electromagnetic wave transmission medium is inserted in the gap between the first and second conductor surfaces. The electromagnetic wave interface apparatus includes the electromagnetic wave supplying portion for supplying electromagnetic waves to the gap between the first and second conductor surfaces. Thus, this configuration of the electromagnetic wave interface apparatus allows electromagnetic waves to propagate through the electromagnetic wave transmission medium. The first structure is disposed on the first conductor surface and reflects electromagnetic waves supplied by the electromagnetic wave supplying portion in a state where the end of the electromagnetic wave transmission medium is inserted in the gap. Similarly, the second structure is disposed on the second conductor surface and reflects electromagnetic waves supplied by the electromagnetic wave supplying portion in a state where the end of the electromagnetic wave transmission medium is inserted in the gap.

Since the interface apparatus for supplying electromagnetic waves to the electromagnetic wave transmission medium for propagating electromagnetic waves is configured as described above, it is possible to suppress leakage of electromagnetic waves from the clearance between the interface apparatus and the electromagnetic wave transmission medium so as to improve power transmission efficiency.

While the case where the patch conductors of the first electromagnetic wave suppressing structure 240 and the second electromagnetic wave suppressing structure 250 have a rectangular shape has been described above, the patch conductors may have other shapes. For example, the patch conductors may have a shape having a smooth boundary, such as any polygon or circle. A conductor having a notch or aperture may be used.

While the case where the first electromagnetic wave suppressing structure 240 and the second electromagnetic wave suppressing structure 250 are mushroom-type EBG structures including a patch conductor and a conductor post has been described above, the electromagnetic wave suppressing structures are not limited to this type. The electromagnetic wave suppressing structures may be other types of EBG structures, as long as they are structures configured to reflect electromagnetic waves propagating in a direction in which the electromagnetic waves leak out.

### Second Embodiment

Now, a second embodiment of the present invention will be described with reference to the drawings. Note that to clarify the invention, description of some of the components which have already been described in the first embodiment will be omitted.

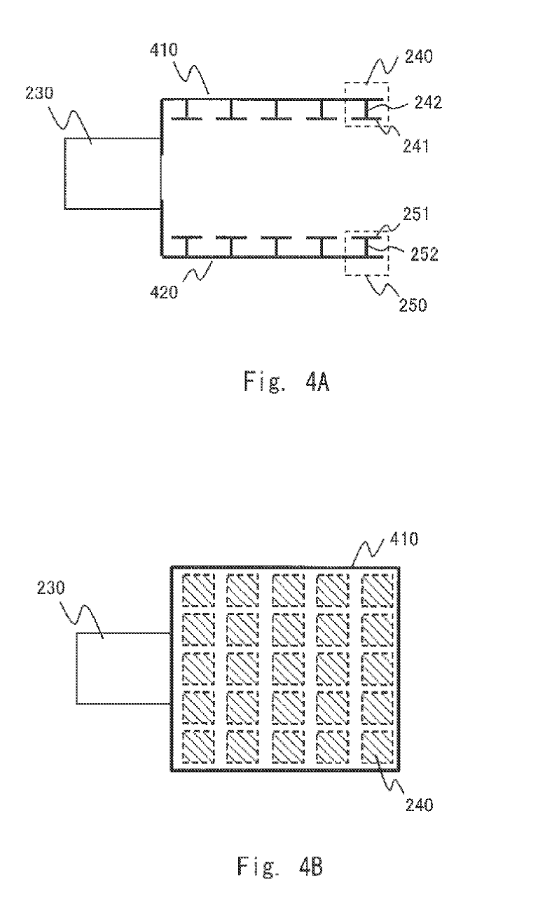

FIG. 4A shows a side view of an interface apparatus 400 according to the second embodiment. FIG. 4B shows a plan view of the interface apparatus 400 according to the second embodiment. In the interface apparatus 400, 25 (5 columns×5 rows) first electromagnetic wave suppressing structures 240 are periodically two-dimensionally arranged on the first conductor surface of a first electrode 410.

As in the first embodiment, the first electromagnetic wave suppressing structures 240 periodically arranged are mushroom-type EBG structures. The first electromagnetic wave suppressing structure 240 are periodically arranged on the first conductor surface at predetermined intervals so that adjacent patch conductors do not contact each other.

When the capacitive coupling between adjacent patch conductors 241 and the inductive coupling caused by adjacent patch conductors 241 and conductor posts 242 and the loop current passing through the first conductor surface of the first electrode 410 serving as a reference conductor are dominant in the first electromagnetic wave suppressing structures 240, the first electromagnetic wave suppressing structures 240 can be regarded as being an equivalent circuit where parallel resonant circuits are connected together in series. On the other hand, when the inductive coupling caused by the conductor posts 242 and the inductive coupling between the patch conductors 241 and the mesh layer 140 of the electromagnetic wave transmission medium 100 are dominant in the first electromagnetic wave suppressing structures 240, the first electromagnetic wave suppressing structures 240 can be regarded as being an equivalent circuit where series resonant circuits are connected together in parallel. The equivalent circuit where parallel resonant circuits are connected together in series has an extremely high characteristic impedance at a particular frequency, whereas the equivalent circuit where series resonant circuits are connected together in parallel has an extremely low characteristic impedance at a particular frequency. Since the disposition of the multiple first electromagnetic wave suppressing structures 240 causes resonance, most of the electromagnetic waves which will leak out are reflected toward the electromagnetic wave supplying portion 230 or reflected so that the electromagnetic waves pass through the mesh layer 140 and enter the electromagnetic wave propagation layer 130. This applies to the second electromagnetic wave suppressing structures 250 as well.

As seen above, in the interface apparatus according to the second embodiment, the multiple first electromagnetic wave suppressing structures are periodically arranged on the first conductor surface of the first electrode, and the multiple second electromagnetic wave suppressing structures are periodically arranged on the second conductor surface of the second electrode. Since the electromagnetic wave suppressing structures are repeatedly disposed as described above, it is possible to further suppress leakage of electromagnetic waves so as to improve power transmission efficiency.

While the configuration where the same number (five) of electromagnetic wave suppressing structures are disposed in both the vertical and horizontal directions on each electrode has been described above, other configurations may be employed. The number of electromagnetic wave suppressing structures may vary in accordance with the direction, for example, one in one direction and three in the other direction. Generally, the electromagnetic wave leakage suppression effect increases as the number of electromagnetic wave suppressing structures in each direction increases. Accordingly, it is preferable to dispose multiple electromagnetic wave suppressing structures in each direction.

The multiple electromagnetic wave suppressing structures disposed on each electrode do not need to have the same physical shape. These structures may be designed to have different physical shapes as long as the frequency of the resonance is close to the frequency band in which suppression of leakage of electromagnetic waves is desired.

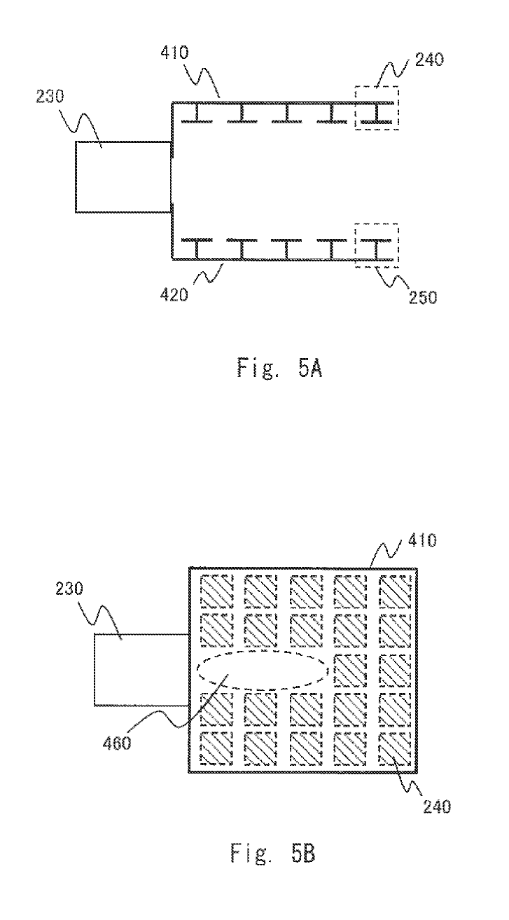

Alternatively, as shown in FIGS. 5A and 5B, a configuration may be employed where a matching adjustment portion 460, instead of forming the electromagnetic wave suppressing structures 240, is disposed in a region adjacent to the electromagnetic wave supplying portion 230 on the first electrode 410 having the multiple electromagnetic wave suppressing structure 240 disposed thereon.

Specifically, in this configuration, multiple electromagnetic wave suppressing structures 240 are not periodically arranged in the region on the electromagnetic wave supplying portion 230 side, which is a region on an inner side of a first boundary of the first conductor surface of the first electrode 410, whereas multiple electromagnetic wave suppressing structures 240 are periodically arranged in the region on an outer side of the first boundary of the first conductor surface of the first electrode 410. The region on the inner side of the first boundary, which is the region on the electromagnetic wave supplying portion side, is defined as the matching adjustment portion 460 serving as a region for matching design.

Since the matching adjustment portion 460 can be used as a region for matching design, power can be transmitted more efficiently. The first boundary, which separates the region where the first electromagnetic wave suppressing structures 240 are periodically arranged on the first electrode 410 and the region where the first electromagnetic wave suppressing structures 240 are not periodically arranged on the first electrode 240 may be determined as appropriate in terms of matching design.

For example, in the interface apparatus 400 shown in FIG. 5A and 5B, the matching adjustment portion 460 is formed by eliminating a line of electromagnetic wave suppressing structures (EBG) from the first electrode 410. By forming the matching adjustment portion 460 corresponding to a line of a finite number of EBGs as described above, matching design can be accomplished using a one-dimensional resonance phenomenon in the elimination region.

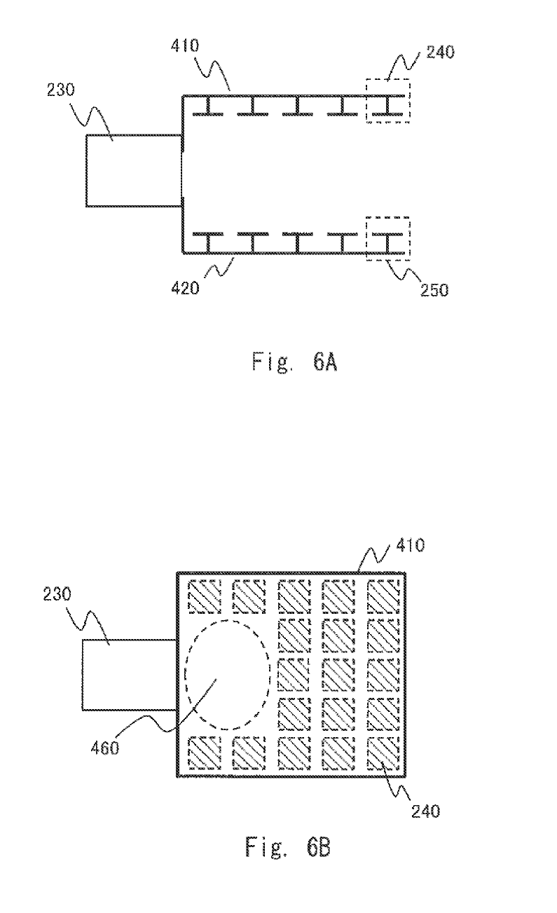

Alternatively, as shown in FIGS. 6A and 6B, a matching adjustment portion 460 serving as a region for matching design may be formed by eliminating a matrix of EBGs from the first electrode 410. By forming the matching adjustment portion 460 corresponding to the matrix of EBGs, matching design can be accomplished using a two-dimensional resonance phenomenon in the elimination region, which can be regarded as being a cavity resonator. By forming the region for matching design that excites the resonant mode of the cavity resonator, it is possible to reduce the length of the interface apparatus 400 to increase the available area of the electromagnetic wave transmission medium 100

The method for forming the matching adjustment portion 460 is not limited to eliminating the first electromagnetic wave suppressing structures 240 from the first electrode 410. That is, a configuration may be employed where multiple electromagnetic wave suppressing structure 250 are not periodically arranged in the region inside a second boundary on the second conductor surface of the second electrode 420; that is, in a region adjacent to the electromagnetic wave supplying portion 230 and where multiple electromagnetic wave suppressing structures 250 are periodically arranged the region outside the second boundary. The region inside the second boundary, which is adjacent to the electromagnetic wave supplying portion, may be defined as being a matching adjustment portion 460 serving as a region for matching design.

### Third Embodiment

Now, a third embodiment of the present invention will be described with reference to the drawings. Note that to clarify the invention, description of some of the components which have already been described in the first and second embodiments will be omitted.

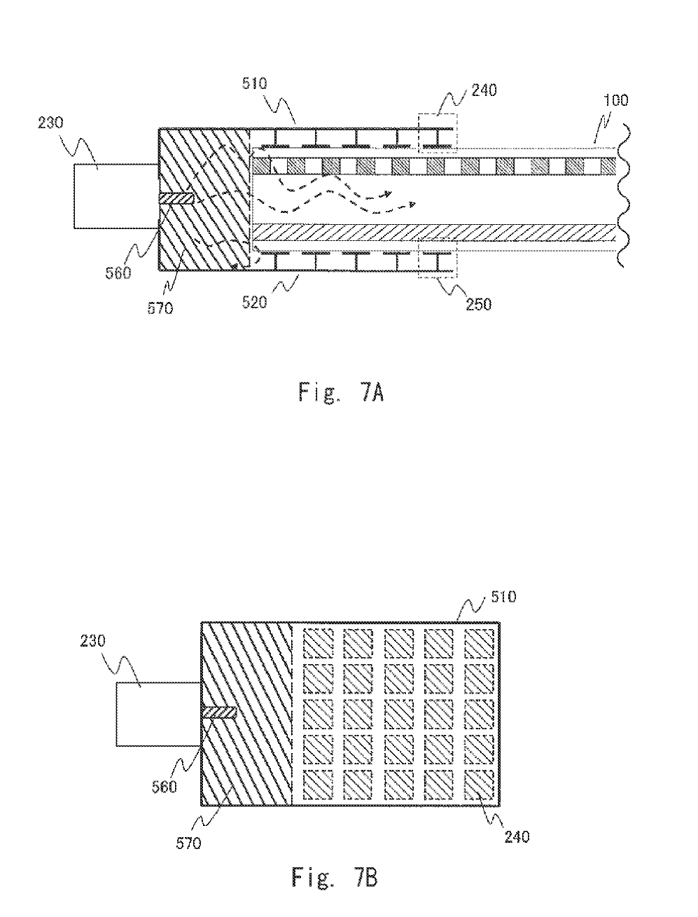

FIGS. 7A and 7B show a side view and plan view, respectively, of an interface apparatus 500 according to the third embodiment. In the interface apparatus 500, a core wire 231 serving as an electromagnetic wave supplying portion 230 is disposed in such a manner as to protrude between the first conductor surface of a first electrode 510 and the second conductor surface of a second electrode 520. In the following description, the protruding core wire may be referred to as a third electrode 560.

The third electrode 560 is protected by a dielectric 570. Specifically, the gap corresponding to a predetermined distance from the electromagnetic wave supplying portion 230 between the first and second conductor surfaces is filled with the dielectric 570. Note that the dielectric 570 may be air. The surface in contact with the electromagnetic wave transmission medium 100 inserted in the interface apparatus 500, of the dielectric 570 is vertical, and matching is accomplished at the joint. The electromagnetic wave transmission medium 100 is inserted between the first and second conductor surfaces until it contacts the vertical surface of the dielectric 570. To prevent electromagnetic waves from leaking from the side surfaces of the dielectric 570, both of the side surfaces are shielded by conductors.

The first electrode 510 and the second electrode 520 are connected to a ground potential by connecting them to the braided wire of the electromagnetic wave supplying portion 230. Thus, the first electrode 510 and the second electrode 520 function as shield electrodes.

Twenty-five (5 columns×5 rows) first electromagnetic wave suppressing structures 240 are periodically two-dimensionally arranged on the first conductor surface of the first electrode 510. In a state where the electromagnetic wave transmission medium 100 is inserted until reaching the vertical surface of the dielectric 570, the first electromagnetic wave suppressing structures 240 are in contact with the front surface of the electromagnetic wave transmission medium 100. These structures reflect electromagnetic waves which will leak out along the front surface of the electromagnetic wave transmission medium 100.

As with the first conductor surface of the first electrode 510, 25 (5 columns×5 rows) second electromagnetic wave suppressing structures 250 are periodically two-dimensionally arranged on the second conductor surface of the second electrode 520.

As seen above, the interface apparatus according to the present embodiment further includes the third electrode, which is disposed in the gap between the first and second conductor surfaces. The electromagnetic wave supplying portion supplies electromagnetic waves to the gap by applying a first alternating-current voltage to the third electrode and connecting the first and second conductor surfaces to a ground potential. In this configuration, the third electrode serving as an internal electrode is separately disposed, and the first and second electrodes function as shield electrodes. Thus, leakage of electromagnetic waves is further suppressed.

At least the gap around the third electrode of the gap between the first and second conductor surfaces is filled with the dielectric, and the side surfaces of the dielectric are shielded by the conductors. Matching is accomplished at the joint between the dielectric and the inserted electromagnetic wave transmission medium, and the shield conductors disposed on both side surfaces of the dielectric are in contact with the inserted electromagnetic wave transmission medium in such a manner that matching is accomplished. Thus, leakage of electromagnetic waves from these joints can be suppressed.

The core wire 231 may be used as an element for matching design as it is, or a conductor which is separately matching-designed may be connected to the core wire 231 as a third electrode. The interior of the dielectric 570 may be used as a region for matching design.

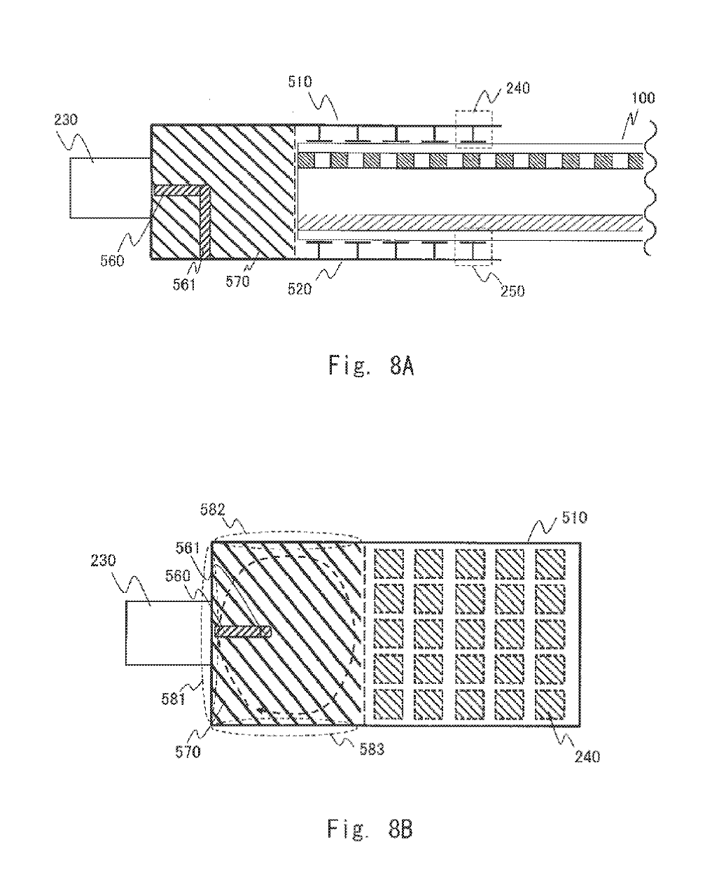

For example, if the dielectric 570 is regarded as being a cavity resonator, electromagnetic waves may be distributed in a resonant mode in such a manner that a magnetic field moves around along a shield conductor 581 disposed on the back of the dielectric 570 and shield conductors 582 and 583 disposed on both surfaces thereof. In this case, as shown in FIGS. 8A and 8B, by connecting a conductor post 561 to the conductor 560, which is connected to the core wire 231, so that the conductor 560 becomes shorted with the bottom conductor, a magnetic field can be generated in the region surrounded by the conductor 560, the conductor post 561, and the bottom conductor. As seen above, by using the element for matching design as a shorting terminal so that a magnetic field occurs easily in the direction of the magnetic field in the resonant mode, as described above, matching design can be accomplished easily.

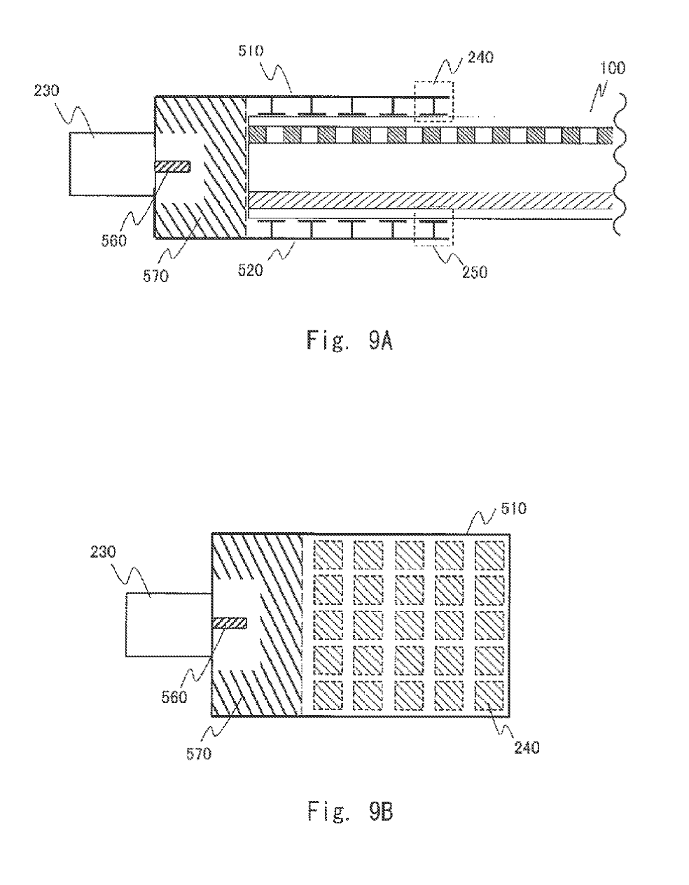

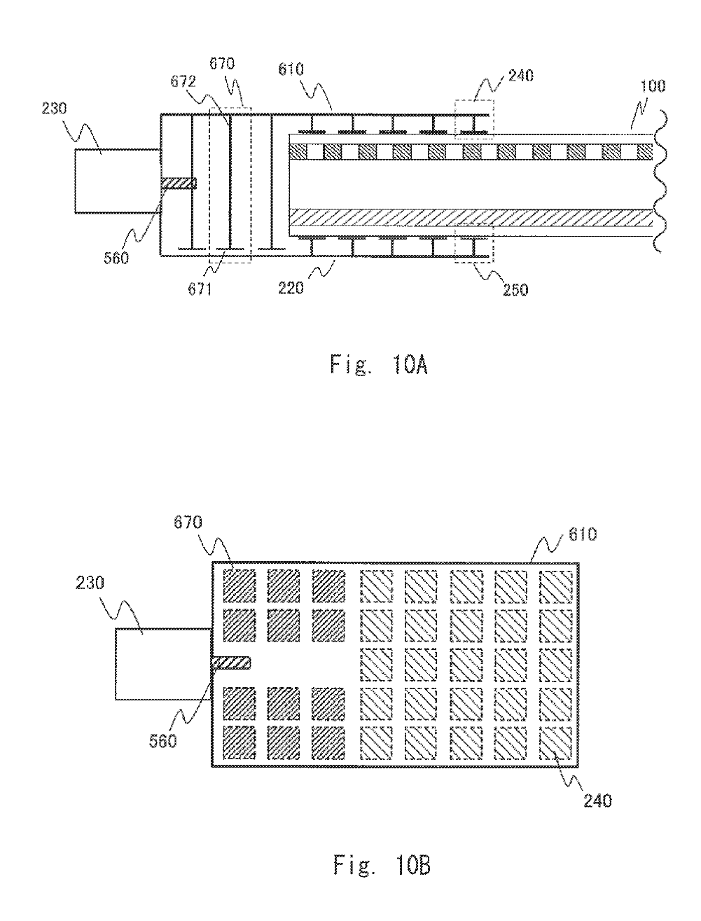

While the configuration where the dielectric 570 is a block-shaped dielectric and where the third conductor 560 is disposed in this block has been described above, other configurations may be employed. For example, as shown in FIGS. 9A and 9B, a configuration may be employed where a recessed dielectric block is disposed in such a manner that the bottom surface thereof, which is a vertical surface, contacts the inserted electromagnetic wave transmission medium 100 and where the third electrode is disposed in the recess. By using this configuration, a region for matching design is ensured, so that manufacturing is facilitated.

### Fourth Embodiment

Now, a fourth embodiment of the present invention will be described with reference to the drawings. Note that to clarify the invention, description of some of the components which have already been described in the first to third embodiments will be omitted.

FIGS. 10A and 10B show a side view and plan view, respectively, of an interface apparatus 600 according to a fourth embodiment. In the interface apparatus 600, first electromagnetic wave suppressing structures 240 as well as third electromagnetic wave suppressing structures 670 are disposed on the first conductor surface of a first electrode 610. The functions of the first electromagnetic wave suppressing structure 240 are similar to those in the first to third embodiments. For this reason, the third electromagnetic wave suppressing structures 670 will be described in detail.

As with a first electromagnetic wave suppressing structure 240, each third electromagnetic wave suppressing structure 670 is an EBG structure including a patch conductor 671 and a conductor post 672. Each conductor post 672 is longer than a conductor post 242. Each patch conductor 671 is located adjacent to the second conductor surface of a second electrode 220.

The third electromagnetic wave suppressing structures 670 are intended to prevent leakage from the side surfaces of electromagnetic waves that the electromagnetic wave supplying portion 230 supplies to the gap between the first and second conductor surfaces.

The third electromagnetic wave suppressing structures 670 are disposed on both sides of a third conductor 560. In FIGS. 10A and 10B, double-layer third electromagnetic wave suppressing structures 670 are disposed in parallel on both sides of the third conductor 560 up to near the inserted electromagnetic wave transmission medium 100.

When the inductive coupling caused by the loop current passing through the first electrode 610 serving as a reference conductor is dominant, the third electromagnetic wave suppressing structures 670 disposed in parallel can be regarded as an equivalent circuit where parallel resonant circuits are connected together in series. When the inductive coupling caused by conductor posts 672 and the inductive coupling between the patch conductors 671 and the second conductor surface of a second electrode 620 are dominant, the third electromagnetic wave suppressing structures 670 can be regarded as an equivalent circuit where series resonant circuits are connected together in parallel. The equivalent circuit where parallel resonant circuits are connected together in series has an extremely high characteristic impedance at a particular frequency, whereas the equivalent circuit where series resonant circuits are connected together in parallel has an extremely low characteristic impedance at a particular frequency. By designing the size of the patch conductor 671, the distance to the second conductor surface, the capacitance of the conductor post 672, or the like so that an extremely high or extremely low characteristic impedance is obtained at the frequency (e.g., 900 MHz) used for communication, it is possible to reflect electromagnetic waves attempting to propagate toward the side surfaces of the apparatus through the third electromagnetic wave suppressing structures 670.

Thus, electromagnetic waves supplied by the electromagnetic wave supplying portion 230 are confined within the resonance region between the third electromagnetic wave suppressing structures 670 disposed on both sides of the third conductor 560. As a result, the electromagnetic waves are amplified in the matching-designed resonance region. The electromagnetic waves use, as a path, only the electromagnetic wave propagation layer 130 of the electromagnetic wave transmission medium 100. In this way, the electromagnetic waves can be efficiently supplied to the receiving apparatus 300 through the electromagnetic wave transmission medium 100.

As seen above, in the interface apparatus according to the fourth embodiment, the first electromagnetic wave suppressing structures and third electromagnetic wave suppressing structures are disposed on the first conductor surface. The first electromagnetic wave suppressing structures are intended to reflect electromagnetic waves supplied by the electromagnetic wave supplying portion and propagating along the surface of the electromagnetic wave transmission medium in a state where the end of the electromagnetic wave transmission medium is inserted in the interface apparatus. On the other hand, the third electromagnetic wave suppressing structures are disposed in parallel on both sides of the third electrode up to near the electromagnetic wave transmission medium. The third electromagnetic wave suppressing structures are intended to reflect electromagnetic waves supplied by the electromagnetic wave supplying portion and propagating toward the side surfaces of the interface apparatus in a state where the end of the electromagnetic wave transmission medium is inserted in the interface apparatus. Use of such a configuration allows electromagnetic waves supplied by the electromagnetic wave supplying portion to be efficiently supplied to the receiving apparatus through the electromagnetic wave transmission medium.

Preferably, matching design is performed so that the resonance region formed by the third electromagnetic wave suppressing structures disposed on both sides of the third electrode resonates in the frequency band of electromagnetic waves for communication. Thus, electromagnetic waves can be supplied more efficiently.

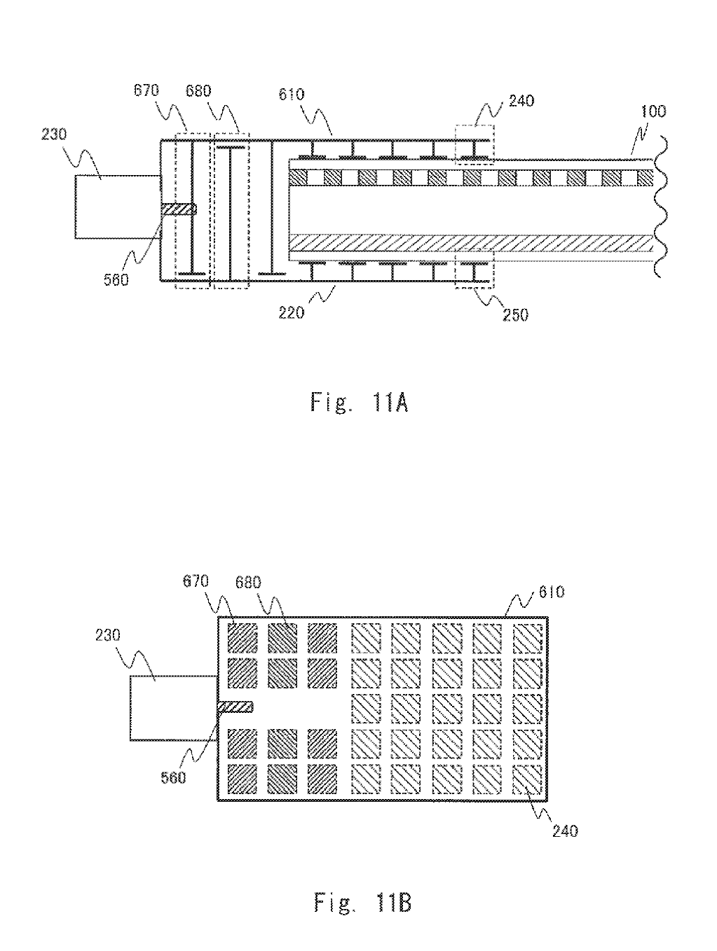

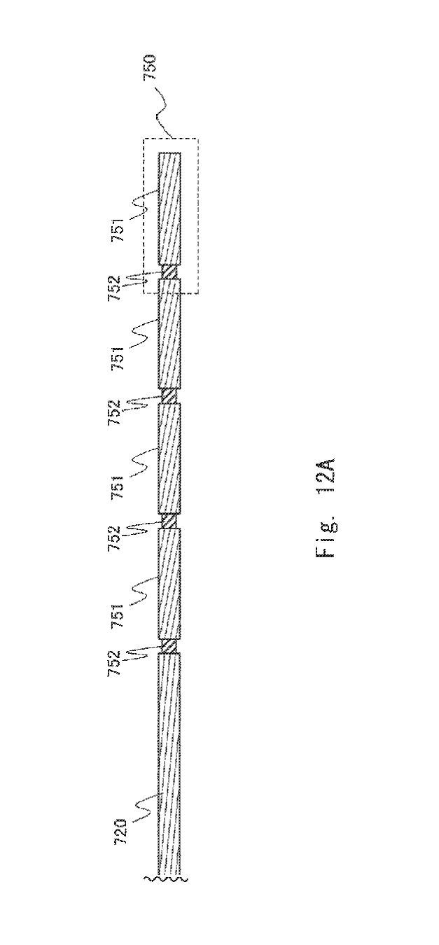

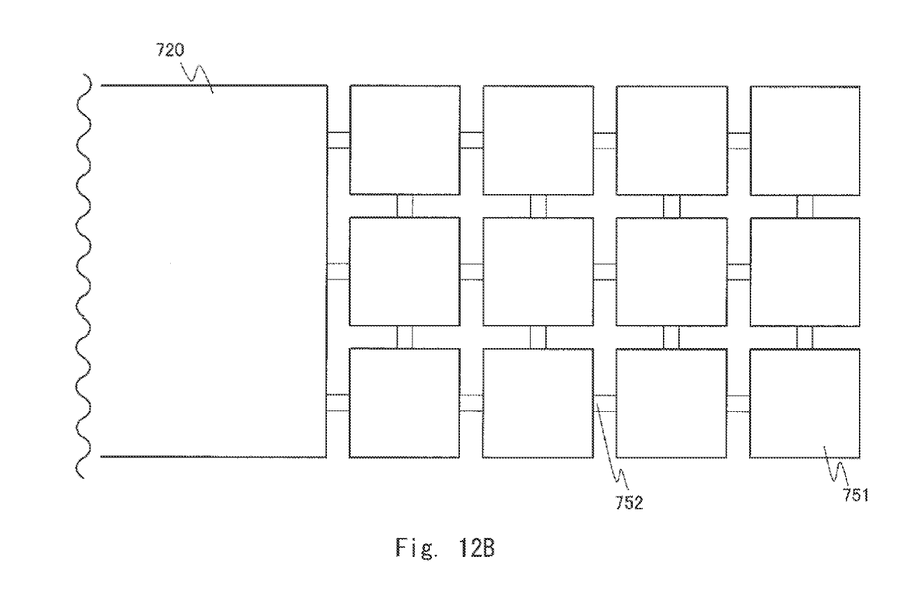

While the configuration where the third electromagnetic wave suppressing structures are disposed on the first conductor surface of the first electrode has been described, other configurations may be employed. The third electromagnetic wave suppressing structures may be disposed on the second conductor surface of the second electrode, or, as shown in FIGS. 11A and 11B, may be disposed on both the first and second conductor surfaces.

### Fifth Embodiment

In an interface apparatus according to a fifth embodiment, second electromagnetic wave suppressing structures disposed on a second electrode are structures other than mushroom-type EBG structures. Now, the fifth embodiment of the present invention will be described with reference to the drawings. Note that to clarify the invention, description of some of the components which have already been described in the first to fourth embodiments will be omitted.

FIGS. 12A and 12B show a sectional view and bottom view, respectively, of the second conductor surface of a second electrode 720 of an interface apparatus 700 according to the fifth embodiment. Multiple flat EBG structures serving as second electromagnetic wave suppressing structures 750 are periodically arranged on the second conductor surface of the second electrode 720. As used herein, “flat EBG structures” refer to multiple EBG structures which can be formed in the same plane.

Each second electromagnetic wave suppressing structure 750 includes a patch conductor 751 and connection lines 752 which electrically connect the patch conductor 751 to adjacent ones. While each connection line 752 is disposed around the midpoint on a side of the corresponding patch conductor 751 in FIGS. 12A and 12B, the connection lines may be disposed in other positions. For example, each connection line 752 may be disposed around an end of the side of the corresponding conductor 751. Further, the number of connection lines 752 connecting adjacent patch conductors 751 is not limited to one, and multiple connection lines 752 may connect adjacent patch conductors 751.

The second electromagnetic wave suppressing structures 750 shown in FIG. 12A also can reflect electromagnetic waves propagating in the leakage direction, toward the electromagnetic wave supplying portion 230 in accordance with the above principle.

The second electromagnetic wave suppressing structures 750, which are flat EBG structures, shown in FIG. 12A do not need a conductor post unlike mushroom-type EBG structures and therefore can be slimmed accordingly. A typical interface apparatus is a clip-type coupler and couples with the electromagnetic wave transmission medium 100 in such a manner as to sandwich the electromagnetic wave transmission medium 100 vertically and horizontally. If the bottom of the interface apparatus is thick, the electromagnetic wave transmission medium 100 may warp, thereby significantly losing the flatness thereof. On the other hand, the second electromagnetic wave suppressing structures 750 according to the second embodiment are flat EBG structures. Thus, those disposed under the electromagnetic wave transmission medium 100 can be sufficiently thinned, so that the high degree of flatness of the medium can be maintained.

As seen above, the second electromagnetic wave suppressing structures according to the present embodiment each include a patch conductor disposed flush with the second conductor surface and connection lines connecting the patch conductor to adjacent ones. By using such EBG structures as the second electromagnetic wave suppressing structures, the thickness thereof can be reduced.

While the case where flat EBG structures are used as the second electromagnetic wave suppressing structures 750 has been described above, flat EBG structures may also be used as first electromagnetic wave suppressing structures 740. By using flat EBG structures also as the first electromagnetic wave suppressing structures 740, the entire interface apparatus 700 can be thinned.

As described in the above embodiments, the interface apparatuses of the present invention can supply electromagnetic waves to the receiving apparatus through the electromagnetic wave communication medium with increased power transmission efficiency.

Note that the electromagnetic wave suppressing structures disposed on the first and second conductor surfaces of each interface apparatus are not limited to the above EBG structures and may be various types of EBG structures.

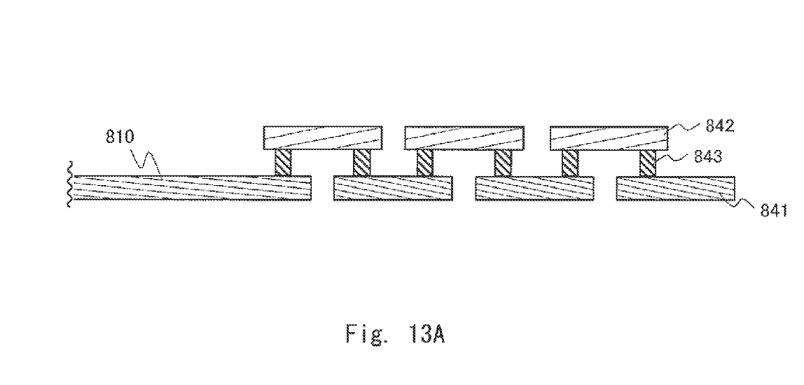

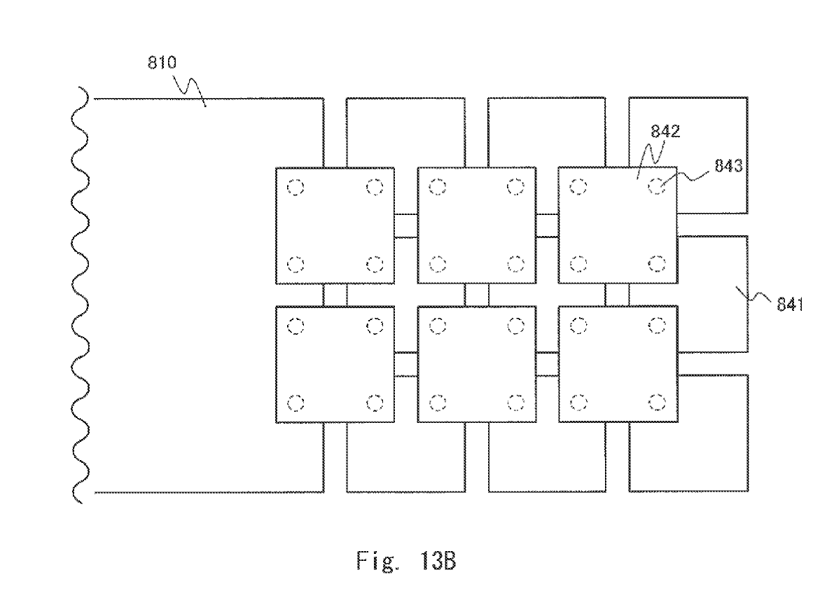

For example, as shown in FIG. 13A and 13B, the electromagnetic wave suppressing structure may include multiple lower-layer patch conductors 841 serving as reference conductors forming the first conductor surface, upper-layer patch conductors 842 mounted on the layer on the side opposite to the electromagnetic wave transmission medium 100, and conductor posts 843 connecting the lower-layer patch conductors 841 and the upper-layer patch conductors 842. The upper-layer patch conductors 842 bridge-connect adjacent lower-layer patch conductors 841 disposed on the first conductor surface. Such multiple EBG structures may be used as the first or second electromagnetic wave suppressing structures.

While the case where the interface apparatus is used to transmit power has been described in the above embodiments, the interface apparatus may be used in other applications. The interface apparatuses of the present invention can be used not only to transmit power but also to supply electromagnetic waves for signals.

The present invention is not limited to the above embodiments, and changes can be made to the embodiments as appropriate without departing from the spirit and scope of the invention. For example, the following configurations may be employed.

### (Supplementary Note 1)

An interface apparatus for supplying electromagnetic waves to a sheet-shaped electromagnetic wave transmission medium for propagating electromagnetic waves, the interface apparatus comprising:
a first conductor surface;
a second conductor surface disposed in an opposed state to and substantially parallel with the first conductor surface;
electromagnetic wave supplying means configured to supply electromagnetic waves to a gap between the first and second conductor surfaces;
a first structure disposed on the first conductor surface and configured to reflect electromagnetic waves supplied by the electromagnetic wave supplying means with an end of the electromagnetic wave transmission medium inserted in the gap; and
a second structure disposed on the second conductor surface and configured to reflect electromagnetic waves supplied by the electromagnetic wave supplying means with the end of the electromagnetic wave transmission medium inserted in the gap.

### (Supplementary Note 2)

The interface apparatus according to Supplementary note 1,
wherein the first structure comprises:
   a plate-shaped patch conductor disposed in an opposed state to and substantially parallel with the first conductor surface; and
   a first conductor post connecting the patch conductor to the first conductor surface, and
wherein the second structure comprises:
   a plate-shaped patch conductor disposed in an opposed state to and substantially parallel with the second conductor surface; and
   a second conductor post connecting the patch conductor to the second conductor surface.

### (Supplementary Note 3)

The interface apparatus according to Supplementary note 1 or 2, wherein the plurality of first structures are periodically arranged on the first conductor surface, and
wherein the plurality of second structures are periodically arranged on the second conductor surface.

### (Supplementary Note 4)

The interface apparatus according to Supplementary note 1, wherein the second structure comprises:
a plurality of plate-shaped patch conductors disposed flush with the second conductor surface; and
connection lines connecting the adjacent patch conductors.

### (Supplementary Note 5)

The interface apparatus according to any one of Supplementary notes 1 to 4,
wherein the electromagnetic wave transmission medium comprises:
a first protective layer which is a sheet-shaped insulator;
a first conductor layer which is a sheet-shaped conductor;
a dielectric layer which is a sheet-shaped dielectric and through which electromagnetic waves propagate;
a second conductor layer which is a mesh sheet-shaped conductor; and
a second protective layer which is a sheet-shaped insulator, and
wherein the first protective layer, the first conductor layer, the dielectric layer, the second conductor layer, and the second protective layer are stacked.

### (Supplementary Note 6)

The interface apparatus according to Supplementary note 5,
wherein the first structure reflects the supplied electromagnetic waves in a direction where the electromagnetic waves are sent into the dielectric layer through the second conductor layer, and
wherein the second structure reflects the supplied electromagnetic waves toward the electromagnetic wave supplying means.

### (Supplementary Note 7)

The interface apparatus according to any one of Supplementary notes 1 to 6, wherein the electromagnetic wave supplying means supplies electromagnetic waves to the gap by applying a first voltage to one of the first and second conductor surfaces and connecting the other conductor surface to a ground potential.

### (Supplementary Note 8)

The interface apparatus according to any one of Supplementary notes 1 to 6, further comprising a third electrode disposed in the gap, wherein
the electromagnetic wave supplying means supplies electromagnetic waves to the gap by applying a first voltage to the electrode and connecting the first and second conductor surfaces to a ground potential.

### (Supplementary Note 9)

The interface apparatus according to Supplementary note 8, further comprising a third structure configured to reflect electromagnetic waves supplied by the electromagnetic wave supplying means disposed on both sides of the third electrode, wherein
the third structure comprises:
   a plate-shaped patch conductor disposed in a position distant from the first conductor surface or the second conductor surface by a predetermined distance in an opposed state to and substantially parallel with the first conductor surface or the second conductor; and
   a conductor post connecting the patch conductor to the second conductor surface or the first conductor surface.

### (Supplementary Note 10)

The interface apparatus according to any one of Supplementary notes 3 to 9, wherein matching adjustment means having at least one of the first and second structures not disposed thereon is disposed adjacent to the electromagnetic wave supplying means.

### (Supplementary Note 11)

The interface apparatus according to any one of Supplementary notes 3 to 10, wherein the first structures are ?not? periodically arranged in a region on the electromagnetic wave supplying portion side which is a region on an inner side of a first boundary on the first conductor surface, and the first structures are periodically arranged in a region on an outer side of the first boundary thereon.

### (Supplementary Note 12)

The interface apparatus according to any one of Supplementary notes 3 to 10, wherein the first structures are not periodically arranged in a region on the electromagnetic wave supplying portion side which is a region on an inner side of a second boundary on the second conductor surface, and the second structures are periodically arranged in a region on an outer side of the second boundary thereon.

While the invention of the present application has been described with reference to the embodiments, the invention is not limited thereto. Various changes understandable for those skilled in the art can be made to the configuration or details of the invention of the present application without departing from the scope of the invention.

The present application claims priority based on Japanese Patent Application No. 2012-004001, filed on Jan. 12, 2012, the disclosure of which is incorporated herein in its entirety.

### REFERENCE SIGNS LIST

100 electromagnetic wave transmission medium

110 first protective layer

111 sheet insulator

120 plane conductor layer

121 sheet conductor

130 electromagnetic wave propagation layer

131 dielectric substrate

140 mesh layer

141 mesh conductor

150 second protective layer

151 sheet insulator

200 interface apparatus

210 first electrode

220 second electrode

230: electromagnetic wave supplying portion

240 first electromagnetic wave suppressing structure

241 patch conductor

242 conductor post

50 second electromagnetic wave suppressing structure

251 patch conductor

252 conductor post

300: receiving apparatus

1. An interface apparatus for supplying electromagnetic waves to a sheet-shaped electromagnetic wave transmission medium for propagating electromagnetic waves, the interface apparatus comprising:
a first conductor surface;
a second conductor surface disposed in an opposed state to and substantially parallel with the first conductor surface;
electromagnetic wave supplying means configured to supply electromagnetic waves to a gap between the first and second conductor surfaces;
a first structure disposed on the first conductor surface and configured to reflect electromagnetic waves supplied by the electromagnetic wave supplying means with an end of the electromagnetic wave transmission medium inserted in the gap; and
a second structure disposed on the second conductor surface and configured to reflect electromagnetic waves supplied by the electromagnetic wave supplying means with the end of the electromagnetic wave transmission medium inserted in the gap.

2. The interface apparatus according to claim 1,
wherein the first structure comprises:
a plate-shaped patch conductor disposed in an opposed state to and substantially parallel with the first conductor surface; and
a first conductor post connecting the patch conductor to the first conductor surface, and
wherein the second structure comprises:
a plate-shaped patch conductor disposed in an opposed state to and substantially parallel with the second conductor surface; and
a second conductor post connecting the patch conductor to the second conductor surface.

3. The interface apparatus according to claim 1, wherein the plurality of first structures are periodically arranged on the first conductor surface, and
wherein the plurality of second structures are periodically arranged on the second conductor surface.

4. The interface apparatus according to claim 1, wherein the second structure comprises:
a plurality of plate-shaped patch conductors disposed flush with the second conductor surface; and
connection lines connecting the adjacent patch conductors.

5. The interface apparatus according to claim 1,
wherein the electromagnetic wave transmission medium comprises:
a first protective layer which is a sheet-shaped insulator;
a first conductor layer which is a sheet-shaped conductor;
a dielectric layer which is a sheet-shaped dielectric and through which electromagnetic waves propagate;
a second conductor layer which is a mesh sheet-shaped conductor; and
a second protective layer which is a sheet-shaped insulator, and
wherein the first protective layer, the first conductor layer, the dielectric layer, the second conductor layer, and the second protective layer are stacked.

6. The interface apparatus according to claim 5,
wherein the first structure reflects the supplied electromagnetic waves in a direction where the electromagnetic waves are sent into the dielectric layer through the second conductor layer, and
wherein the second structure reflects the supplied electromagnetic waves toward the electromagnetic wave supplying means.

7. The interface apparatus according to claim 1, wherein the electromagnetic wave supplying means supplies electromagnetic waves to the gap by applying a first voltage to one of the first and second conductor surfaces and connecting the other conductor surface to a ground potential.

8. The interface apparatus according to claim 1, further comprising a third electrode disposed in the gap, wherein
the electromagnetic wave supplying means supplies electromagnetic waves to the gap by applying a first voltage to the electrode and connecting the first and second conductor surfaces to a ground potential.

9. The interface apparatus according to claim 8, further comprising a third structure configured to reflect electromagnetic waves supplied by the electromagnetic wave supplying means disposed on both sides of the third electrode, wherein
the third structure comprises:
a plate-shaped patch conductor disposed in a position distant from the first conductor surface or the second conductor surface by a predetermined distance in an opposed state to and substantially parallel with the first conductor surface or the second conductor; and
a conductor post connecting the patch conductor to the second conductor surface or the first conductor surface.

10. The interface apparatus according to claim 3, wherein matching adjustment means having at least one of the first and second structures not disposed thereon is disposed adjacent to the electromagnetic wave supplying means.
